(19) United States
(12) Patent Application Publication
(10) Pub. No.: US 2017/0202718 A1
(43) Pub. Date: Jul. 20, 2017

(54) BED FOR PATIENT

(71) Applicant: DK City Corporation, Taichung (TW)

(72) Inventor: Chiu Hsiang Lo, Taichung (TW)

(21) Appl. No.: 15/000,701

(22) Filed: Jan. 19, 2016

(51) Int. Cl. A61G 7/015; A61G 7/075; A61G 7/018

(52) U.S. Cl. CPC A61G 7/015; A61G 7/018; A61G 7/0755

(57) ABSTRACT

A bed includes a sliding unit movable on a base and a linkage unit including a following element, a board, a connecting rod, a swinging element and a hydraulic cylinder. The following element is connected to the sliding unit. The board is connected to the following element so that they are rotatable together to and from the sliding unit. The connecting rod includes an end connected to the sliding unit. The swinging element includes an end connected to the connecting rod and another end connected to a head crossbar of the base. The hydraulic cylinder includes a pivotal end connected to the base and an extensible end connected to the swinging element. Thus, the swinging element can be pivoted upwards to actuate the connecting rod to move the sliding unit toward the head crossbar and actuate the connecting rod to push the board.

### BACKGROUND OF INVENTION

1. Field of Invention

The present invention relates to medical care and, more particularly, to a bed for a patient.

2. Related Prior Art

Patients who suffer serious injuries or diseases spend a lot of time in beds. Such a bed is often equipped with a mechanism that includes a crank operable to raise the patient's body so that the patient can eat, take medicine and/or read.

However, when the patient is raised, he or she is moved away from a bedside cabinet on or in which food, medicine or a book is placed, to the disadvantage of the patient trying to get the food, medicine or book. Moreover, the patient relies on another person to operate the crank.

To solve the foregoing problem, a bed has been devised in Taiwanese Patent No. 1327900. The bed includes a base 10, a connecting frame 30, a body-supporting frame 20, a leg-supporting frame 40 and an elevating frame 50. The connecting frame 30 includes two crossbars 31 and four rollers 36. The rollers 36 are movable on two tracks 11 of the base 10. The body-supporting frame 20 includes two rods 22 pivotally connected to the first crossbar 31. A hydraulic cylinder 32 includes an end pivotally connected to a lever 24 of the body-supporting frame 20 and another end pivotally connected to the second crossbar 31. The leg-supporting frame 40 includes two rods 41 pivotally connected to the second crossbar 31. A hydraulic cylinder 33 includes an end pivotally connected to a lever 43 of the leg-supporting frame 40 and another end pivotally connected to the first crossbar 31. The elevating frame 50 includes two rods (not numbered) each including an end pivotally connected to the rods 41. There are two connecting rods 38 each including an end connected to the connecting frame 30 and another end connected to another end of a corresponding one of the rods of the elevating frame 50. Thus, the patient's body will not be moved away from the bedside cabinet when the patient's body is raised. However, the operation of the bed is not stable or smooth for at least two reasons. Firstly, the rollers 36 might rattle on the tracks 11, and the former might escape from the latter in the worst scenario. Secondly, the front and leg-supporting frames 20 and 40 and the elevating frame 50 are connected to the connecting frame 30, which is movable on the supporting frame 20 in operation.

The present invention is therefore intended to obviate or at least alleviate the problems encountered in prior art.

### SUMMARY OF INVENTION

It is an objective of the present invention to provide a bed that can be operated stably and smoothly.

It is another objective of the present invention to provide a bed that can be maintained easily.

To achieve the foregoing objectives, the bed includes a base, a sliding unit and a linkage unit. The sliding unit is movable on the base. The linkage unit includes a following element, a board, a connecting rod, a swinging element and a hydraulic cylinder. The following element is pivotally connected to the sliding unit. The board is connected to the following element so that they are rotatable together to and from the sliding unit. The connecting rod includes an end pivotally connected to the sliding unit. The swinging element includes an end pivotally connected to the connecting rod and another end pivotally connected to a head crossbar of the base. The hydraulic cylinder includes a pivotal end pivotally connected to the base and an extensible end pivotally connected to the swinging element. Thus, the swinging element can be pivoted upwards to actuate the connecting rod to move the sliding unit toward the head crossbar and actuate the connecting rod to push the board.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a bed according to the preferred embodiment of the present invention;

FIG. 2 is an exploded view of the bed shown in FIG. 1;

FIG. 3 is an exploded view of a body-supporting unit of the bed shown in FIG. 1;

FIG. 4 is a perspective view of the body-supporting unit shown in FIG. 1;

FIG. 5 is a side view of the body-supporting unit of FIG. 4;

FIG. 6 is a side view of the body-supporting unit in another position than shown in FIG. 5; and

FIG. 7 is a side view of the body-supporting unit in another position than shown in FIG. 6.

### DESCRIPTION OF PREFERRED EMBODIMENT

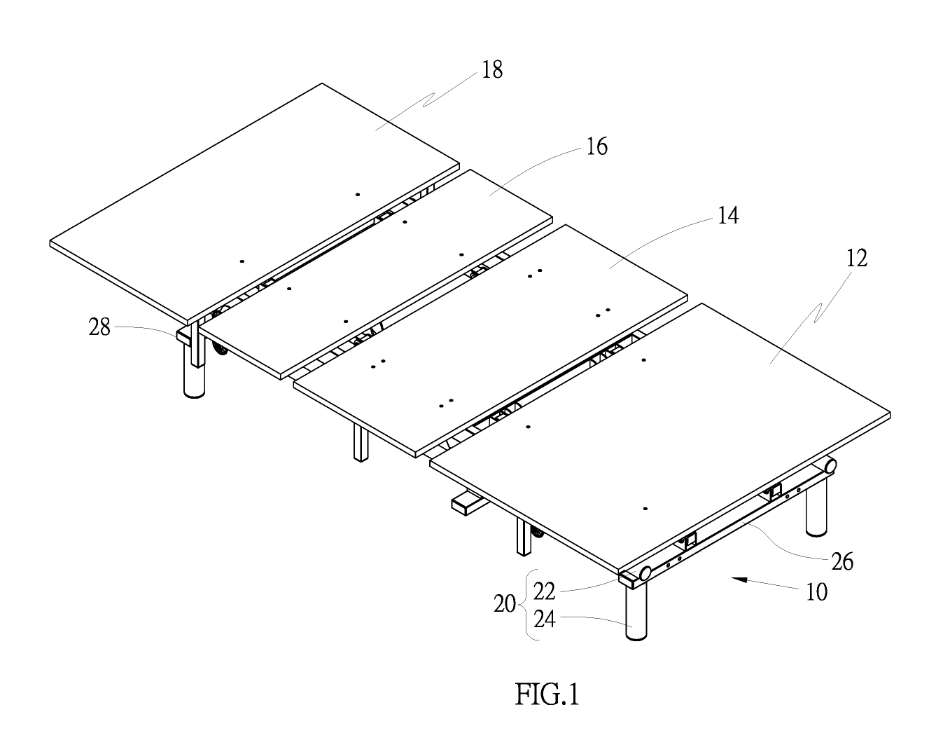

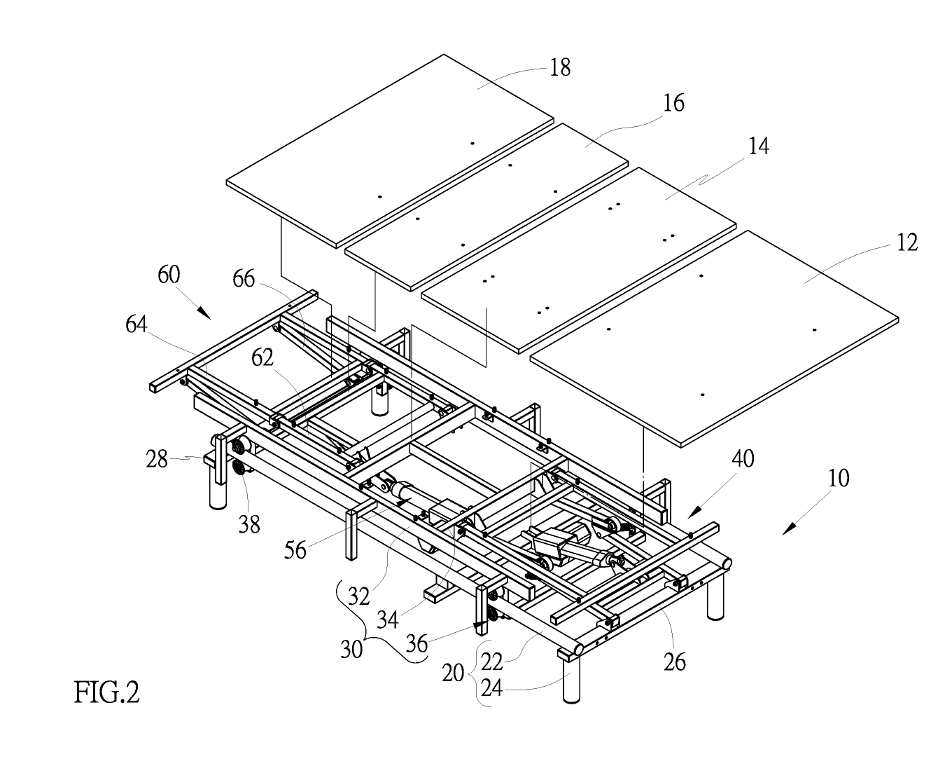

Referring to FIGS. 1 and 2, a bed 10 includes four boards 12, 14, 16 and 18, a base 20, a sliding unit 30 and two linkage units 40 and 60 according to the preferred embodiment of the present invention. The board 12, 14, 16 and 18 are supported on the linkage units 40 and 60 and the sliding unit 30.

The base 20 is substantially a rectangular frame that includes two tracks 22, four posts 24, a head crossbar 26, a middle crossbar 27 and a tail crossbar 28. The tracks 22 are located above and connected to the head crossbar 26, the middle crossbar 27 and the tail crossbar 28. The tracks 22 are preferably circular tubes. The head crossbar 26 is supported on two of the posts 24 at two ends. The tail crossbar 28 is supported on the other posts 24 at two ends. The base 20 can be firmly laid on the ground or a floor due to the use of the posts 24.

The sliding unit 30 includes two longitudinal rods 32, two transverse rods 34 and four roller units 36. Each of the longitudinal rods 32 extends parallel to a corresponding one of the tracks 22 when the sliding unit 30 is movably connected to the base 20. The transverse rods 34 are located between and connected to the longitudinal rods 32. Two of the roller units 36 are connected to one of the longitudinal rods 32 while the other roller units 36 are connected to the other longitudinal rod 32. Each of the roller units 36 includes two rollers 38 each including an annular groove (not numbered) that is arched in a cross-sectional view. In each of the roller units 36, one of the rollers 38 is located on a corresponding one of the tracks 22 while the other roller 38 is located beneath the corresponding track 22.

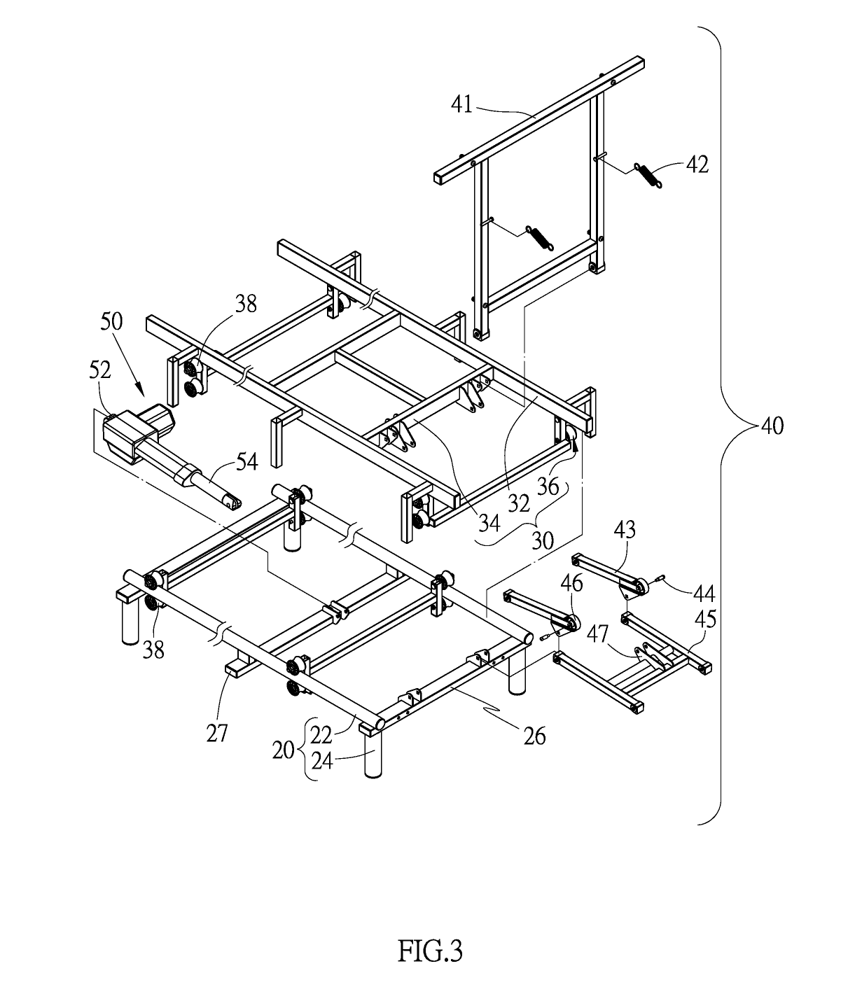

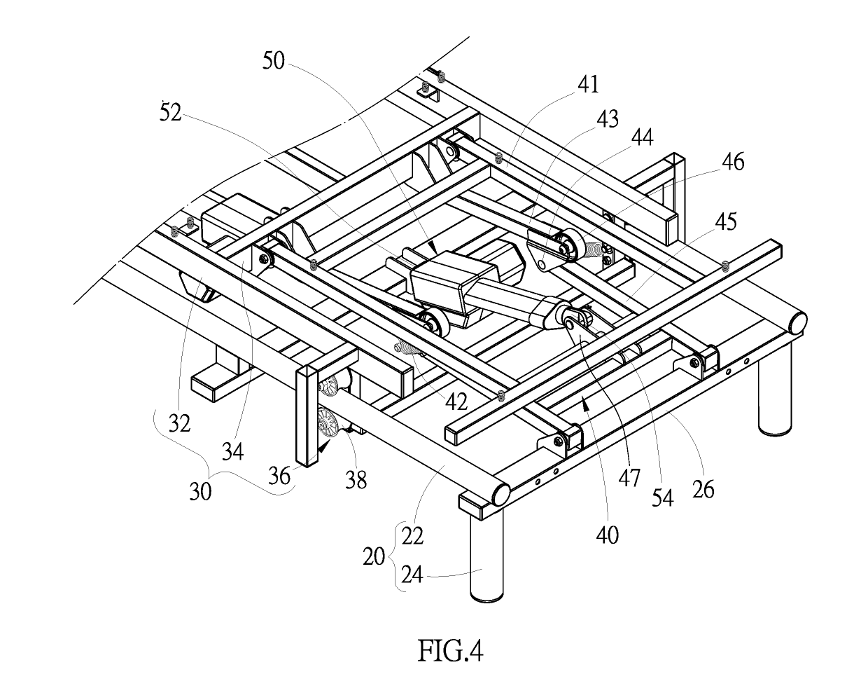

Referring to FIGS. 3 through 7, the body-supporting unit 40 includes a following element 41, two tension springs 42, two connecting rods 43, two pins 44, a swinging element 45, two rollers 46, two lugs 47 and a hydraulic cylinder 50. The following element 41 is substantially a rectangular frame that includes two crossbars (not numbered) and two lateral bars (not numbered) connected to the crossbars thereof. The first board 12 is connected to the first crossbar of the following element 41 by screws for example. The lateral bars of the following element 41 are pivotally connected to the first transverse rod 34. Thus, the following element 41 can be pivoted relative to the sliding unit 30.

The swinging element 45 is a substantially H-shaped frame that includes two lateral bars (not numbered) and a middle portion located between and connected to the lateral bars thereof. Each of the lateral bars of the swinging element 45 includes an end pivotally connected to the head crossbar 26 of the base 20.

The connecting rods 43 includes an end pivotally connected to the first transverse rod 34 and another end pivotally connected to another end of a corresponding one of the lateral bars of the swinging element 45 by a corresponding one of the pins 44. The connecting rods 43 are located between the lateral bars of the following element 41 when all of the connecting rods 43 and the following element 41 are lowered.

Preferably, each of the rollers 46 is connected to the first end of a corresponding one of the connecting rods 43. However, each of the rollers 46 can be connected to a corresponding one of the lateral bars of the swinging element 45 in an alternative embodiment. The rollers 46 are adapted for contact with the first board 12 so that the total weight of the first board 12 and the following element 41 is well carried without causing excessive friction that would otherwise entail unnecessary damage.

Each of the tension springs 42 includes an end connected to a corresponding one of the lateral bars of the following element 41 and another end connected to a corresponding one of the pins 44. Thus, the following element 41 is biased toward the connecting rods 43 by the tension springs 42.

The hydraulic cylinder 50 includes a pivotal end 52 connected to the middle crossbar 27 of the base 20 and an extensible end 54 pivotally connected to the lugs 47, which are connected to the middle portion of the swinging element 45 by welding for example.

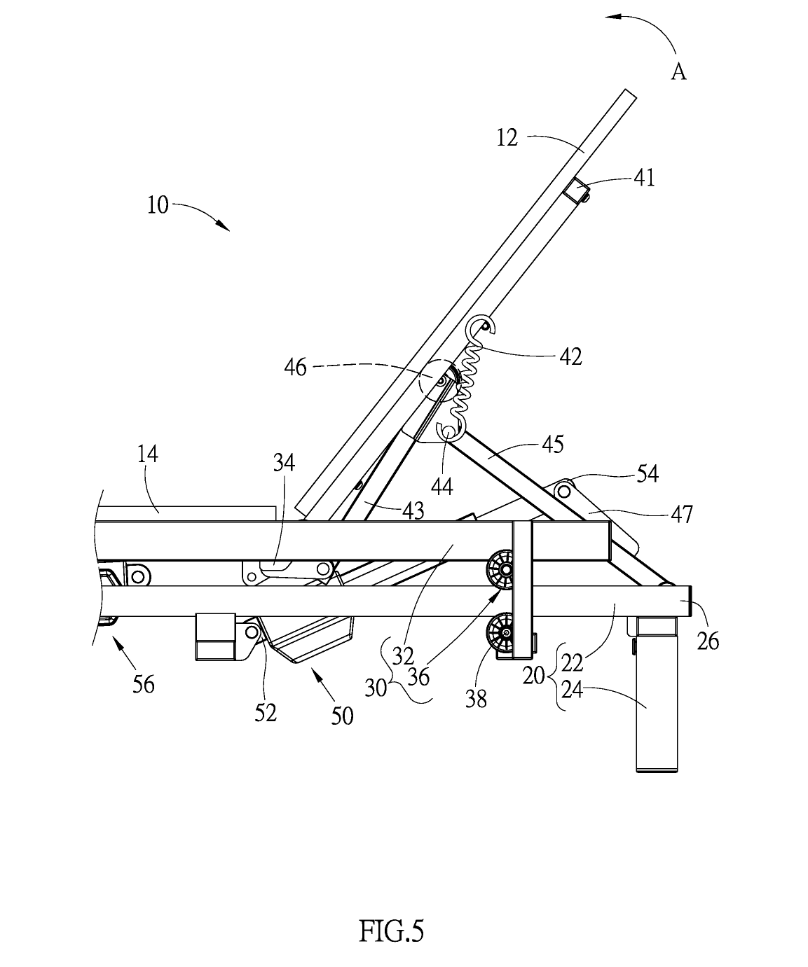

Referring to FIG. 5, the hydraulic cylinder 50 extends to pivot the swinging element 45 upwards. Accordingly, the connecting rod 43 moves the sliding unit 30 toward the head crossbar 26 of the base 20. At the same time, the rollers 46, which are attached to the connecting rod 43, push the first board 12 and the following element 41 upwards as indicated by an arrowhead A.

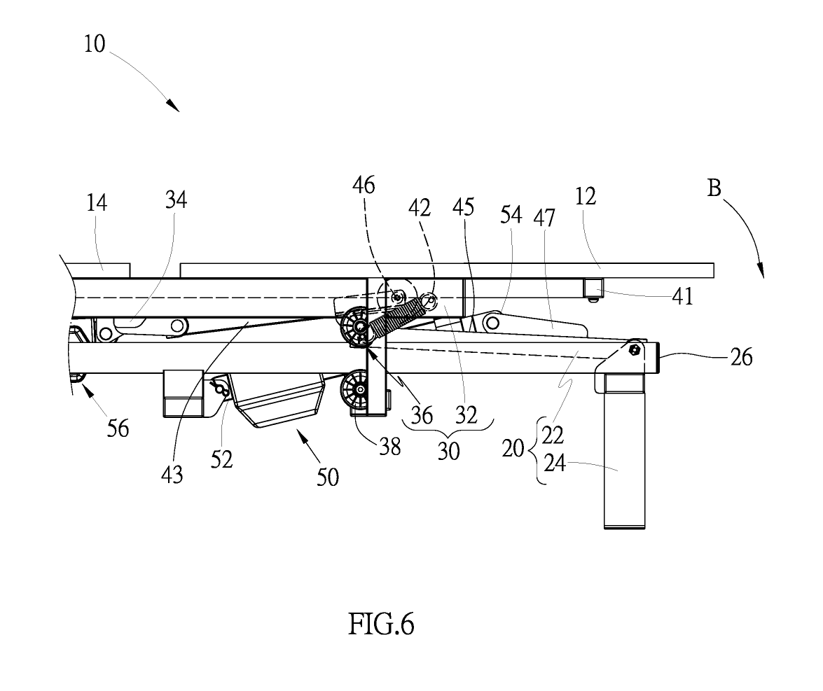

Referring to FIG. 6, the hydraulic cylinder 50 withdraws to allow the swinging element 45 to pivot downwards. Accordingly, the connecting rod 43 moves the sliding unit 30 from the head crossbar 26 of the base 20. At the same time, the rollers 46 allow the first board 12 and the following element 41 to pivot downwards as indicated by an arrowhead B.

The first board 12 and the following element 41 can be pivoted between the position shown in FIG. 5 and the position shown in FIG. 6. Synchronously, the sliding unit 30 can be moved between the position shown in FIG. 5 and the position shown in FIG. 6. The movement of the sliding unit 30 is stable and smooth in the pivoting upwards and downwards of the first board 12 and the following element 41.

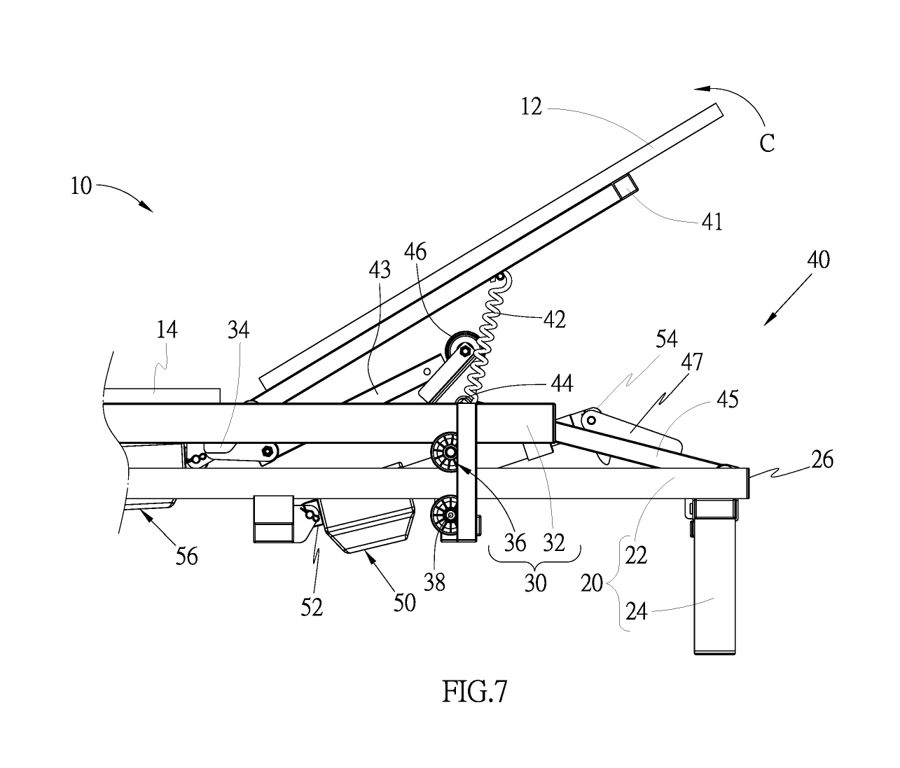

Referring to FIG. 7, the following element 41 is pivoted from the connecting rods 43 in a direction indicated by an arrowhead C. Thus, the sliding unit 30 and the first linkage unit 40 can quickly be inspected, maintained and repaired by a mechanic

Referring to FIG. 2, the leg-supporting unit 60 includes two frames 62 and 64 and two supporting elements 66. Each of the frames 62 and 64 includes two lateral bars (not numbered). Each of the lateral bars of the frame 62 includes an end pivotally connected to an end of a corresponding one of the lateral bars of the frame 64 and another end pivotally connected to the second transverse rod 34. Each of the supporting elements 66 includes an end pivotally connected to the sliding unit 30 above the tail crossbar 28 of the base 20 and another end pivotally connected to another end of a corresponding one of the lateral bars of the frame 64 opposite to the connectors 62. Preferably, the supporting elements 66 are square tubes. However, the supporting elements 66 can be in another proper shape in an alternative embodiment.

A hydraulic cylinder 56 includes a pivotal end pivotally connected to the second transverse rod 34 and an extensible end connected to the frame 62. Thus, the frame 62 can be pivoted relative to the transverse rod 34 of the sliding unit 30 by the hydraulic cylinder 56. Hence, the frame 64 can be pivoted between a raised position and a lowered position by the hydraulic cylinder 56 via the frame 62 and the supporting elements 66.

The second board 14 is connected to the transverse rods 34 so that the second board 14 is only movable together with the sliding unit 30. The third board 16 is connected to the frame 62 while the fourth board 18 is connected to the frame 64. Therefore, the third board 16 and the frame 62 are kept in a tilted position while the fourth board 18 and the frame 64 are kept in a horizontal position. That is, the bed 10 can be partially folded.

Advantageously, the operation of the bed is stable for several reasons. Firstly, the sliding unit 30 is stably movable on the base 20 due to the extension of each of the tracks 22 between the corresponding rollers 38. Secondly, and end of each of the lateral bars of the swinging element 45 is connected to the head crossbar 26 of the base 20, which stands still in operation. Thirdly, the pivotal end 52 of the hydraulic cylinder 50 is connected to the middle crossbar 27 of the base 20, which stands still in operation.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A bed comprising:
a base comprising a head crossbar;
a sliding unit movably supported on the base;
a body-supporting unit comprising:
a following element pivotally connected to the sliding unit;
a board connected to the following element so that they are rotatable together to and from the sliding unit;
at least one connecting rod comprising an end pivotally connected to the sliding unit;
a swinging element comprising an end pivotally connected to the head crossbar of the base and another end pivotally connected to another end of the connecting rod; and
a hydraulic cylinder comprising a pivotal end pivotally connected to the base and an extensible end pivotally connected to the swinging element so that the swinging element can be pivoted upwards to actuate the connecting rod to move the sliding unit toward the head crossbar of the base and actuate the connecting rod to push the board.

2. The bed according to claim 1, wherein the body-supporting unit further comprises a spring formed with an end connected to the connecting rod near the swinging element and another end connected to the following element, thus keeping the following element in the lowered position.

3. The bed according to claim 1, wherein the body-supporting unit further comprises a roller connected to one of the connecting rod and the swinging element and adapted to push a board connected to the following element.

4. The bed according to claim 1, wherein the base further comprises two tracks extending parallel to each other, wherein the sliding unit comprises:
two longitudinal rods extending substantially parallel to the tracks;
a transverse rod connected to the longitudinal rods, the following element and the connecting rod; and
roller units connected to the longitudinal rods, wherein each of the roller units comprises two rollers between which a corresponding one of the tracks extends so that the sliding unit is smoothly movable on the base.

5. The bed according to claim 1, further comprising a leg-supporting unit comprising:
a first frame comprising an end pivotally connected to the sliding unit;
a second frame comprising an end pivotally connected to another end of the first frame frame;
at least one supporting element comprising an end pivotally connected to another end of the second frame and another end pivotally connected to the sliding unit; and
a hydraulic cylinder comprising a pivotal end pivotally connected to the sliding unit and an extensible end connected to the first frame so that the first frame can be pivoted relative to sliding unit and the second frame can be moved between an upper horizontal position and a lower horizontal position via the supporting element.
